(19) United States
(12) Patent Application Publication
(10) Pub. No.: US 2021/0288910 A1
(43) Pub. Date: Sep. 16, 2021

(54) NETWORK INTERFACE DEVICE WITH SUPPORT FOR HIERARCHICAL QUALITY OF SERVICE (QOS)

(71) Applicant: Intel Corporation, Santa Clara, CA (US)

(72) Inventors: Daniel DALY, Santa Barbara, CA (US); Anjali Singhai JAIN, Portland, OR (US); Chih-Jen CHANG, Union City, CA (US); Edmund CHEN, Sunnyvale, CA (US); Robert HATHAWAY, Fair Haven, NJ (US); Naru Dames SUNDAR, Los Gatos, CA (US); Pawel SZYMANSKI, Gdansk (PL); John MANGAN, Shannon (IE)

(21) Appl. No.: 17/332,815

(22) Filed: May 27, 2021

Related U.S. Application Data
(60) Provisional application No. 63/114,969, filed on Nov. 17, 2020.

(51) Int. Cl. H04L 12/815; H04L 12/851; H04L 12/935

(52) U.S. Cl. CPC H04L 47/22; H04L 49/30; H04L 47/24

(57) ABSTRACT

Examples described herein relate to a network interface device and in some examples, the network interface device includes an Ethernet interface, a host interface, circuitry to be configured to copy a packet payload from a host device through the host interface, form a packet based on the packet payload, and transmit the packet through the Ethernet interface, and circuitry to be configured to apply rate limiting and/or traffic shaping for packets received through the Ethernet interface based on hierarchical quality of service (H-QoS). In some examples, the circuitry is to be configured to apply rate limiting and/or traffic shaping for packets received through the Ethernet interface based on H-QoS comprises a programmable packet processing pipeline that is to be configured to perform one or more of: packet drops of packets received in excess of a receive rate, packet drops based on packet transmission in excess of a transmit rate, and/or traffic shaping of the received packets prior to transmission through one or more output ports. In some examples, to perform packet drops of packets received in excess of a receive rate, the programmable packet processing pipeline is to perform rate limiting per one or more of: class of service, subscriber, service, or interface.

### RELATED APPLICATION

This application claims priority to U.S. Provisional Application No. 63/114,969, filed Nov. 17, 2020. The entire contents of that application is incorporated by reference in its entirety.

### DESCRIPTION

In the field of networking, packet hierarchical quality of service (H-QoS) and packet processing are used in connection with sending and receiving packet traffic to and from individual subscribers and/or wired or wireless devices. H-QoS can track individual subscribers and modify transmit rates within the traffic stream for one or more individual subscribers. The packet processing can involve programmability and flexibility to handle a varying set of packet headers. Application of H-QoS can involve traffic being held in a network interface device in memory (e.g., dynamic random access memory (DRAM)), buffering and scheduling the packets to avoid overwhelming a downstream network interface device in the network. In some cases, a programmable pipeline is to adopt a software defined networking (SDN) approach of splitting the dataplane and control plane, allowing the production system to be composed of a commodity dataplane with a control plane that attaches to the dataplane using Programming Protocol-independent Packet Processors (P4) as a standard SDN protocol. This SDN separation enables a multi-vendor eco-system for these edge platforms and applications, driving down costs and increasing end-customer choice.

Network functions can be implemented in software (for flexibility, at relatively high cost) or implemented using programmable router application specific integrated circuits (ASICs). Software solutions can leverage commercial off-the-shelf (COTS) server components (e.g., central processing unit (CPU), DRAM, network interface controller (NIC)) to build a commodity datapath and can run the P4-specified rules and SDN control plane in the same CPU sub-system, but can be costly in the amount of CPU resources needed to scale to higher bandwidths. Programmable router ASICs may require additional investment to work in a COTS server and adopt P4 in order to leverage the SDN ecosystem. An ASIC can require special integration to expose it as a commodity data path for third party control planes that integrate using P4, which adds additional cost to the final solution.

### BRIEF DESCRIPTION OF THE DRAWINGS

FIG. 1A shows an example of a network interface device that can apply H-QoS on packets received from a network.

FIG. 1B depicts an example manner of allocated one or more queues to different sources of packets.

FIG. 2 depicts an example of H-QoS applied at a network interface device.

FIG. 3 depicts an example where H-QoS can be employed on a transmit port.

FIG. 4 depicts an example operation of a network interface device to apply H-QoS.

FIG. 5 shows an example of packet processing.

FIG. 6 depicts an example network interface device.

FIG. 7 depicts an example network forwarding system that can be used in a network interface device to apply H-QoS described herein.

FIG. 8 depicts an example computing system.

### DETAILED DESCRIPTION

A network interface device can be used to provide programmable packet processing pipeline along with traffic shaping, buffering, and congestion management. Traffic shaping can include rate limiting a transmit rate of packets for a subscriber. A network interface device can refer to a network interface controller (NIC), smartNIC, infrastructure processing unit (IPU), data processing unit (DPU), network interface card, fabric interface or any interface to a communications medium. A network interface device can include a programmable packet processing pipeline that can be programmed by a control plane using a packet processing pipeline language. Examples of packet processing pipeline languages include P4, Broadcom Network Programming Language (NPL), or others. In some examples, a network interface device can be configured using an SDN or other controller to perform operations of a switch, router or gateway, instead of or in addition to performing operations of an endpoint or receiver for packets. A network interface device can be a discrete device coupled to a host by a high speed interface. A network interface device and one or more processors can be built as Multi-Chip-Packages (MCP), System-On-Chip (SoC) or as combination of MCP and SoC and discrete devices connected using a high speed interface.

A commercial off the shelf (COTS) or proprietary server can be coupled to a network interface device with a programmable data plane and the server configure the programmable data plane to perform packet processing, packet buffering and H-QoS in the network interface device. A control plane (e.g., SDN) can execute on a server CPU core(s) or a processor of the network interface device. Virtual network functions (VNFs) can be deployed at network edge or in a data center and the network interface device can support packet buffering, traffic shaping, and managing subscriber traffic.

A programmable pipeline of a network interface device can (1) rate limit (e.g., drop packets that exceed a receive rate) in response to packet receipt or (2) shape (e.g., buffer excess packets) prior to packet transmission. One or more queues whose content is managed by a traffic manager can be used to store packets prior to transmission or after receipt. A traffic manager can be implemented as one or more processors that execute instructions provided by a control plane. A network interface device can enforce varying QoS policies such as a maximum rate on receive (with drops), traffic shaping into downstream devices on transmit, H-QoS, or other QoS, to pace traffic.

A network interface device can apply multiple rate limiters and/or shapers on one or more packets. A network interface device can perform one or more configurable same or different H-QoS rate limits, shapers, and/or weights for different nodes in the H-QoS representing per-device, per-port, per-subscriber, per-flow, and/or per-service node. For example, a network interface device can apply a traffic shaper at a flow level and a traffic shaper at port level (e.g., ingress port or egress port). A network interface device can provide per-subscriber class of service (CoS) queues. In deployments where physical queues are filled, a system can have subscribers with the same CoS profile and subscriber weight share a scheduler queue (e.g., CoS Ridesharing) and enforce individual subscriber maximum rates.

A flow can be a sequence of packets being transferred between two endpoints, generally representing a single session using a known protocol. Accordingly, a flow can be identified by a set of defined N tuples and, for routing purpose, a flow can be identified by tuples that identify the endpoints, e.g., the source or destination addresses. For content based services (e.g., load balancer, firewall, intrusion detection system etc.), flows can be identified at a finer granularity by using five or more tuples (e.g., source address, destination address, IP protocol, transport layer source port, destination port, URL, etc.). A packet in a flow is expected to have the same set of tuples in the packet header.

The flow associated with each packet can be identified by examining an n-tuple in the header of each packet. The n-tuple can include L3 (e.g., Internet protocol (IP) layer) and L4 (e.g., transport layer) addresses of the packet, as well as a protocol used to communicate packets. L3 addresses include the source IP address and the destination IP address of the packet. L4 addresses include source and destination transport port numbers.

A packet may be used herein to refer to various formatted collections of bits that may be sent across a network, such as Ethernet frames, IP packets, TCP segments, UDP datagrams, etc. Also, as used in this document, references to L2, L3, L4, and L7 layers (or layer 2, layer 3, layer 4, and layer 7) are references respectively to the second data link layer, the third network layer, the fourth transport layer, and the seventh application layer of the OSI (Open System Interconnection) layer model.

A network interface device can perform one or more of the following: (1) applying to a packet (with multiple levels of hierarchy (e.g., H-QoS)) multiple rate limiters, multiple traffic shapers, and/or multiple weights; (2) CoS queues for received packets and/or packets prior to transmission; (3) port-to-port switching; and/or (4) packet caching and buffering in system memory. A server, network interface device, and/or software can apply SDN to a 5G edge device to perform traffic shaping and H-QoS at least for 5G User Plane Function (UPF) applications.

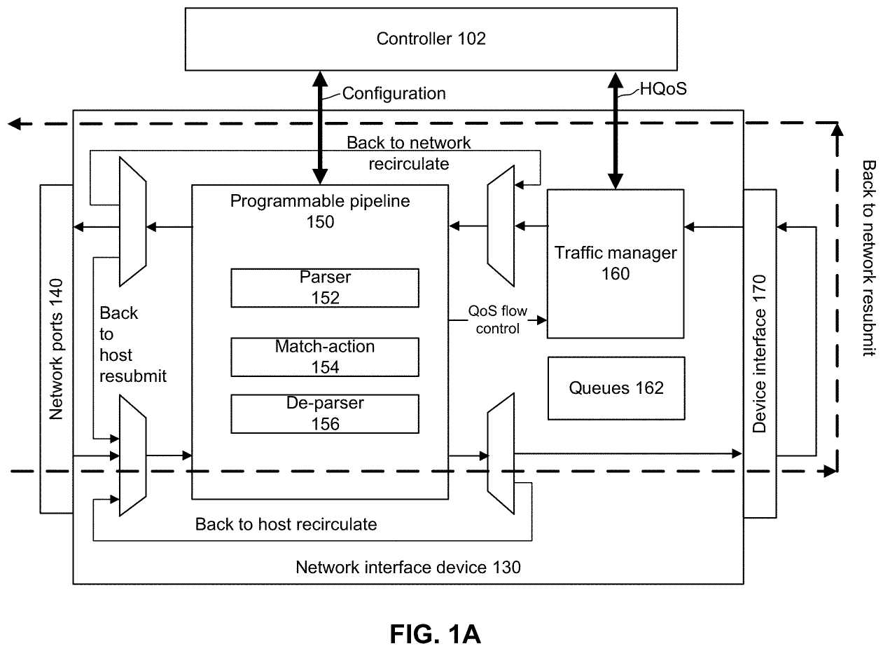

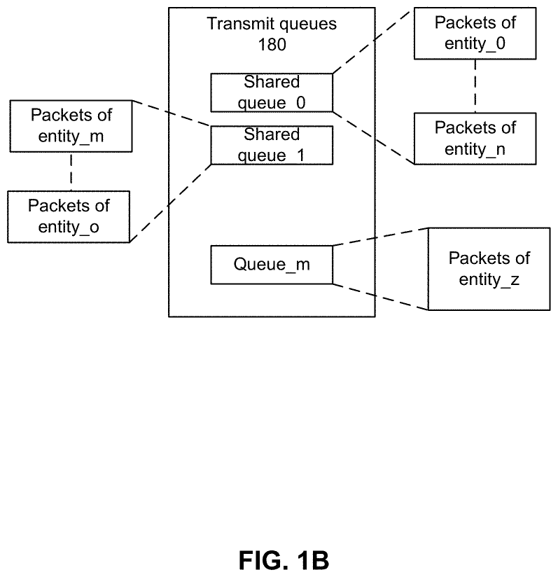

FIG. 1A shows an example of a network interface device that can apply H-QoS on packets received from a network. Network interface device 130 can be configured to receive packets, apply H-QoS on packets, and transmit all or less than all of the received packets to another network interface device. Network interface device 130 can include one or more of: a network interface controller, network interface card, SmartNIC, infrastructure processing unit (IPU), data processing unit (DPU), switch, router, and so forth or combination thereof. Controller 102 can program or configure programmable pipeline 150 to perform dropping of packets received from a network via network ports 140 based on receive rate and/or traffic shaping packets prior to transmission to a next device through network ports 140 based on one or more of: per-device, per-port, per-subscriber, per-flow, and/or per-service node. Packet dropping can occur based on meeting or exceeding a specified receive rate of packets. Traffic shaping can include policing and shaping to identify and respond to traffic violations against a configured permitted rate and perform actions such as dropping or re-marking excess traffic. Policing may not delay traffic in some examples. Shaping can attempt to limit traffic transmission peak rates to limit spikes above an SLA-contracted rate by buffering or delaying packet traffic to transmit until transmit bandwidth is available.

Controller 102 could configure programmable pipeline 150 and/or traffic manager 160 to apply H-QoS. Controller 102 can be implemented as an SDN application that may program packet processing performed by programmable pipeline 150 using a program (e.g., SONiC/SAI.p4) that configures both physical networking and network termination and configures the packet processing specific to the application such as where non-dropped packets are buffered (e.g., app.p4). For example, controller 102 could utilize OpenConfig interface with H-QOS Yet Another Next Generation (yang) to add or remove subscribers over time, change downstream device packet rates, change permitted packet transmit rates, and/or schedule parameters such as allowable times or intervals when bursts of packets can exceed a transmit rate and/or receive rate for a subscriber. For example, operations of programmable pipeline 150, including hash-lookup operations, can be configured using a programmable packet processing pipeline language.

In some examples, controller 102 can program programmable pipeline 150 to classify subscribers, apply meters per flow (or meters for H-QOS), and/or apply rate limiting to drop packets that have exceeded a particular transmit rate or receive rate. Controller 102 can configure network interface device 130 to limit transmit and/or receive bandwidth usage per subscriber. In the transmit direction, at least for a subscriber, programmable pipeline 150 can perform rate limiting by dropping packets when a particular receive rate is exceeded or can permit the transmit rate of packets to be above a transmit rate limit for a particular burst or time amount and then drop packets to enforce subscriber rate limits. For example, a subscriber identifier can be in a packet header (e.g., n tuple, virtual local area network (VLAN) tag, or tunnel identifier (ID)).

Controller 102 can program match-action unit(s) 154 of programmable pipeline 150 to determine a queue to store a received packet based on the packet's source IP address and/or source MAC address. In some examples, a queue can be associated with a class of service (COS), traffic class (TC), virtual machine, container, and/or virtual server instance (VSI). In some examples, one or more queues among queues 162 can store packets associated with same service level agreement (SLA) parameters despite being associated with different COS, TC, virtual machine, container, and/or VSI. Controller 102 can program match-action unit(s) 154 of programmable pipeline 150 to enforce rate limits per queue among queues 162. For example, match-action unit(s) 154 can apply an action of incrementing a count of packets for a match of a particular combination of header fields (e.g., one or more n-tuple fields) in a received packet. For example, match-action unit(s) 154 can apply an action of determining if a receive rate is exceeded for packets of a particular queue or queues and/or particular combination of header fields and either performing one or more packet drops, rate limiting and/or allowing the receive rate to be exceeded and storing the packet receive rate to provide for billing of excess bandwidth utilization.

Controller 102 can program match-action unit(s) 154 of programmable pipeline 150 to perform rate limiting for packets to be transmitted from one or more queues of queues 162. For example, match-action unit(s) 154 can apply an action of determining if a transmitted rate is exceeded for packets of a particular queue or queues and/or particular combination of header fields and either performing one or more packet drops, rate limiting and/or allowing the transmit rate to be exceeded and storing the packet transmit rate to provide for billing of excess bandwidth utilization.

Some received packets for which H-QoS are to be applied can be provided to device interface 170, which can provide the packets to traffic manager 160 and queues 162 for transmission through one or more ports of network ports 140. Device interface 170 can be any type of interface such as at least one or more of: Peripheral Component Interconnect (PCIe) or Compress Express Link (CXL). Device interface 170 can provide a connection to a server, computing platform, and/or one or more processors. In some examples, instead of routing packets through device interface 170 for subsequent transmission, received packets for which H-QoS are to be applied can be stored in a receive queue and the receive queue is identified to be a source of packets for transmission.

In some examples, queues 162 are used to store received packets that are pending to be transmitted. Traffic manager 160 can receive an indication that a packet is ready to be transmitted (e.g., queue number identifying a queue in queues 162 and that a packet is available to transmit). Traffic manager 160 can apply H-QoS based scheduling for packet transmission.

Network interface device 130 can make certain approximations when implementing H-QoS. For example, a network interface device that supports 200 Gbps could utilize queues at multiple levels of scheduling such as 8×50 Kbps×2 queues in the first level, 50 Kbps×2 in the second level, 50 Kbps in the third level and 4 queues in the fourth level.

Network interface device 130 can perform work preserving per-Subscriber Scheduling. Within a subscriber context, queuing of an order in which packets are pulled out of the CoS nodes can be scheduled based on strict priority followed by weighted round robin to ensure that data such as voice always goes through first, and data such as video is given a minimum allocation of the remaining bandwidth.

Network interface device 130 can perform cross subscriber fairness. Across subscribers, relative weights can be used to ensure a minimum bandwidth guarantee across subscribers. Certain subscribers (e.g., business, or premium customer) could be given higher weight so a percentage of available bandwidth is higher in the presence of queuing or congestion.

Network interface device 130 can perform per-subscriber bandwidth limiting. A bandwidth limit per subscriber can be applied according to a service level agreement (SLA).

Network interface device 130 can perform service node protection. A congestion occurring at a downstream service node, can trigger cross-subscriber fairness and per-subscriber scheduling features.

Network interface device 130 can perform interface bandwidth protection to prevent the scheduler from over-scheduling traffic out of an uplink port. Head of line (HOL) blocking can be reduced or avoided and bandwidth allocations across the upstream layers can be reduced accordingly to fit within the interface constraint.

FIG. 1B depicts an example manner of allocating packets from one or different sources to a same queue or set of queues. A queue can be used to store received packets or packets prior to transmission. For example, shared queue_0 can be allocated to store packets for different entities (e.g., entity_0 to entity_n) for which the same SLA transmit parameters are to be applied (e.g., same rate limits and/or packet drop schemes). Entity_0 to entity_n can represent different VMs, containers, VSIs, accelerator devices, or other devices, and even same or different traffic classes. Similarly, shared queue_1 can be used to store packets of different entities (e.g., entity_m to entity_o) for which the same SLA transmit parameters are to be applied (e.g., same rate limits and/or packet drop schemes). In some cases, a queue can be used for a single entity or traffic class such as queue_m for packets of entity_z.

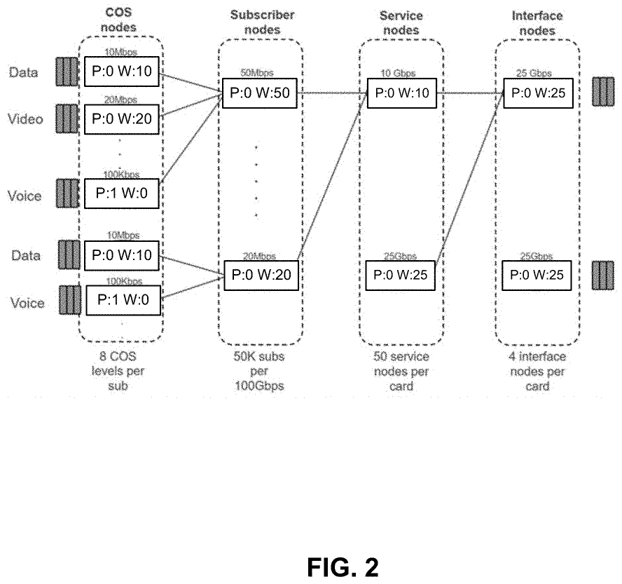

FIG. 2 depicts an example of H-QoS applied at a network interface device in a broadband network gateway (BNG). However, H-QoS can be applied at other locations. In some examples, received packets carry data, video, and/or voice and a network interface device allocates transmit bandwidth to received packets according to multiple layers of QoS. In some examples, bandwidth can be allocated for one or more layers of QoS for packets stored in queues. A queue could have a configurable depth where if packets are queued for too long a time, new packets received into that queue could be dropped (e.g., tail-dropped).

A priority level and weight can be associated with a node in a layer. Note that this example shows 4 layers of QoS applied, namely, for class of service (COS) nodes, subscriber nodes, service nodes, and interface nodes. However, there could be another layer of QoS applied for service nodes if there are multiple layers of devices that the data passes through. COS nodes can provide 8 classes of service per subscriber (sub), although other numbers of classes of service can be utilized such as 2, 4, 16, or more. A priority 0 (P:0) and weight 10 (W:10) COS node can apply transmit scheduling to provide a guarantee of at least 10 Mbps transmit bandwidth for data traffic in a queue. A priority 0 and weight 20 COS node can apply transmit scheduling to provide a guarantee of at least 20 Mbps transmit bandwidth for video traffic in a queue. A priority 1 and weight 0 COS node can apply transmit scheduling to provide a guarantee of at least 100 Kbps transmit bandwidth for voice traffic in a queue. A priority 0 and weight 10 COS node can apply transmit scheduling to provide a guarantee of at least 10 Mbps transmit bandwidth for data traffic in a queue. A priority 1 and weight 0 node can provide a guarantee of at least 100 Kbps transmit bandwidth for voice traffic in a queue.

If there is available transmit bandwidth for packets from multiple queues, a queue with a highest priority can be selected for transmission to reduce jitter. For example, priority 0 can represent a highest priority. For tied priority levels, use round robin. A weight can represent a number of times within a transmission window or quanta that a node can schedule a packet associated with the weight for transmission. A weight of 0 can indicate best efforts transmission scheduling.

Subscriber nodes can represent transmit scheduling based on candidate packets scheduled for transmission from one or more associated COS nodes. For example, subscriber nodes can allocate 100 Gbps bandwidth to 50,000 subscribers. For example, data traffic in a queue scheduled for transmission at 10 Mbps, video traffic in a queue scheduled for transmission at 20 Mbps, and voice traffic scheduled for transmission at 100 Kbps associated with COS nodes can be allocated to a subscriber node with transmission rate of 50 Mbps and having priority 0 and weight 50. For example, data traffic in a queue scheduled for transmission at 10 Mbps and voice traffic scheduled for transmission at 100 Kbps associated with COS nodes can be allocated to a subscriber node with transmission rate of 20 Mbps and having priority 0 and weight 20.

A service node can represent subscriber or traffic aggregation or congestion point in a network such as a router or mobile backhaul switch. In some examples, 50 service nodes can be allocated per network interface device card. For example, traffic scheduled by a 50 Mbps priority 0 and weight 50 subscriber node and 20 Mbps priority 0 and weight 20 subscriber node can be further scheduled for transmission by a 10 Gbps priority 0 and weight 10 service node.

Interface nodes can represent a physical port and/or logical port such as a tunnel. In some examples, interface nodes can provide 4 interface nodes per network interface device card. For example, traffic scheduled by a 10 Gbps priority 0 and weight 10 service node and 25 Gbps priority 0 and weight 25 service node further scheduled for transmission by a 10 Gbps priority 0 and weight 10 interface node.

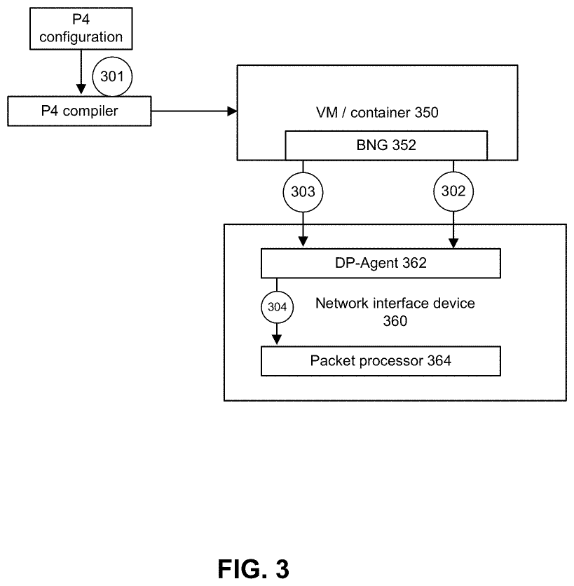

FIG. 3 depicts an example where H-QoS can be employed for a transmit port at a core network prior to transmission to a backhaul network. Some amount of the traffic can follow the path from right-to-left, passing through the H-QoS on port0 egress and the network interface device (e.g., switch) can perform port-to-port switching in hardware for non-exception traffic. At 301, prior to runtime, a configuration for a packet processing pipeline can be compiled to produce a target binary or kernel and information file and the target binary or kernel and information file can be provided to a broadband networking gateway (BNG) 352 associated with a VM or container 350. At 302, BNG 352 can use an interface to manage a network interface device (e.g., SmartNIC) 360 platform such as setting H-QoS settings sent to a DP-Agent (data plane agent 362 executed by a processor) using an interface. An interface can include Google remote procedure call (gRPC) including gRPC based Network Management Interface (gRPC) and/or gRPC based Network Operations Interface (gNOI). At 303, BNG 352 can initiate runtime interface and issue a SetPipelineForwarding request with target binary or kernel and information file to network interface device 360. At 304, DP-Agent 362 executed by a processor can initialize a packet processing pipeline 364 using the target binary to apply H-QoS according to one or more layers or levels of QoS.

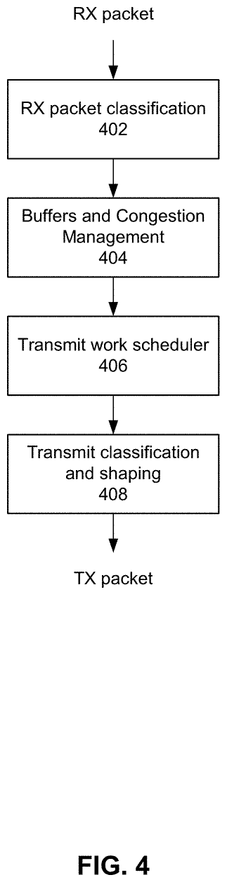

FIG. 4 depicts an example operation of a network interface device to apply H-QoS. A network interface device can provide H-QoS and service nodes to shape traffic to mitigate downstream congestion points as well as enforce per-subscriber bandwidth limits. To apply H-QoS solution, a network interface device can perform receive (RX) packet classification, storage into a cache (e.g., system level cache (SLC)) buffer and/or memory, congestion management (e.g., tail drop or weighted random early detection (wRED)), packet egress scheduling by a traffic manager or work scheduler, packet transmit (TX) classification, and packet transmit shaper. For packets received at a receive (RX) port, at 402, a flexible packet processor (FXP) or packet processor can classify a received packet to its associated subscriber and apply the configured actions, such as accounting or counting received packets per subscriber. At 404, buffer and congestion management can apply QoS such as hard packet count limits per subscriber (with burst support) at receive to drop received packets that exceed rate limits and enqueue packets to an assigned CoS queue with congestion management, such as depths enforced on receive using a watermark per queue.

At 406, transmit work scheduler can dequeue data from a cache, SLC buffer, or memory based on CoS of a subscriber to ensure that strict high priority packets are pulled out first, followed by the remaining classes based on their relative weights. In some examples, subscribers may share the same CoS profile if (a) all of their queues have the same strict priority queues, (b) all of their round robin queues all have the same weights, and/or (c) the subscribers have the same weight across the second level of subscriber scheduling.

At 406, transmit work scheduler can perform CoS ridesharing aggregation to attempt to provide prioritization of strict high priority traffic, and a minimum bandwidth so that work preserving per-subscriber scheduling (referenced earlier) can be satisfied. CoS ridesharing can be used to group subscriber traffic with the same CoS profile and subscriber weight into shared queues that are serviced together in the work scheduler, while still being shaped on an individual subscriber basis. CoS ridesharing can be used to satisfy service level agreements (SLAs) as well as subscriber priority across the groups of queues collected into CoS rideshares. The weighted round robin weight of a shared CoS queue can be multiplied by the number of subscribers sharing that queue, and the subscribers share that allocation. This shared approach can enforce the SLAs configured per-subscriber while enabling larger scale through work scheduler queue sharing.

At 406, instantaneous packet ordering by the transmit work scheduler may be different than an ideal case when ridesharing is employed. This may have no measurable effect on the steady state performance or quality of the connection at the subscriber level. Rate limits can be applied per transmit work scheduler, while queue depth limits are applied per CoS queue.

At 406, across subscribers, the work scheduler can pick which subscriber is permitted to transmit a packet next based on a weighted round robin (WRR) policy across all subscribers, or other policy. Depending on a configurable policy, a new subscriber may be grouped in with another set of subscribers and share CoS queues (e.g., CoS ridesharing). In this case the weights of the non-strict CoS queues can be increased to account for the new subscriber in the rideshare. This can provide for subscribers across work scheduler queues being fairly scheduled, so that cross subscriber fairness (referenced earlier) can be satisfied across CoS rideshares. Within a rideshare on a shared CoS queue, traffic can come from several different subscribers and can be serviced in the order they are received. This traffic can be at the same CoS and subscriber priority and can be held against their respective shaper rate.

At 408, on transmit, a programmable packet processor can classify one or more packets and can apply one or multiple simultaneous shapers on the packet. For example, shapers can include: (1) Shaper Per Subscriber whereby a meter associated with this packet's subscriber is checked so that Per-Subscriber Bandwidth Limit of an exemplary H-QoS solution can be satisfied; (2) Shaper Per Service Node/Backhaul Layer whereby meters associated with this packet's service nodes/backhaul layers can be checked and data can be paced out to ensure that individual bandwidth limits at service nodes are not exceeded so that service node protection of an exemplary H-QoS solution (referenced earlier) can be satisfied; (3) shaper per interface whereby based on the packet's destination port, a meter is checked and if it is over limit to provide that the data out of each port is not overwhelmed with data to satisfy interface bandwidth protection (referenced earlier); and (4) Queue Depth Per Shaper whereby one or more of the service node/backhaul and interface shapers have a buffer limit assigned that will cause dropping of new packets classified into these shapers if the watermark is crossed to avoid having too much traffic backing up into memory for a given downstream node and/or port.

At 408, packets in the process of being shaped on transmit can be stored in cache or off-chip network interface device memory. Packets buffered in this can be tracked per CoS queue and over time may cross a configurable watermark which will trigger flow control back into the work scheduler. Memory can be used for packet classifications, buffering packets as they are turned from receive to transmit, and maintaining a scheduling state. Congestion management can provide certain protections in place on the receive path to ensure that malicious packets or traffic patterns cannot trigger these memory limitations by causing lots of buffering or stalling.

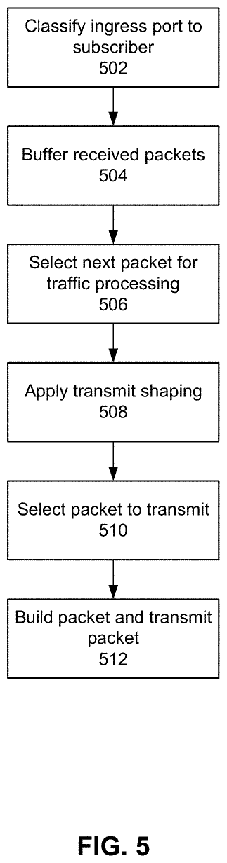

FIG. 5 shows an example traffic flow. At 502, packets at an ingress port can be classified to a subscriber that is rate limited to the subscriber's maximum bandwidth and burst size. In some cases, exceeding the limit causes new packets to be dropped and counted. The packet can also be classified into a class of service (CoS) queue. Congestion management can provide quota for this queue that can be checked so that if the queue is full (over the quota), the packet is dropped and counted against the quota overage. If not dropped, the packet is sent to traffic manager and placed into that RX queue.

At 504, the traffic can be port-to-port switched using buffers in cache and/or memory accessible to a network interface device. To switch packets from receive to transmit, an RX queue with received packets can be designated as a TX queue. Packets in a TX queue can be placed into a queue in the traffic scheduler for counting and transmission.

At 506, the traffic scheduler can select a next packet queued in the TX queue to send for processing by the programmable packet processor. At 508, the programmable packet processor processes packets and checks the packet against the transmit shaper hierarchy to apply one or more layers or levels of bandwidth shaping or limiting as described herein. At 510, the transmit scheduler can identify a next packet to transmit based on applicable shaping rate. Shaping can include packet egress scheduling or per-flow shaping that determines how long a flow or group of flows is resident on buffer before sent out. The next packet ready to be sent out can be scheduled to transmit from the TX queue. At 512, the network interface device generates a packet to transmit using the payload of the packet in a TX queue, applies any packet header or payload modifications performed by a packet processor, and sends the packet out of an egress port.

An example feature set of H-QoS can include (1) 1,000,000 rate limiters per device, applying up to 2 rate limits and up to 6 shapers simultaneously on a packet (6 levels of hierarchy); (2) 12,000 CoS queues with up to 6 levels of hierarchy; (3) 150 Mpps Port-to-Port Switching and H-QoS with a 3 microsecond fall-through latency; (4) 32 MB packet cache with Deep Buffering in memory (e.g., dynamic random access memory (DRAM)) for multiple GBs of packet buffer; and (5) Programmable Pipeline for Classification to H-QoS.

The following provides example configurations. For a single CoS queue, single Subscriber, the following configurations can be used: 1 CoS queue and 1 flow classified into a shaper set at 10 Mbps. For traffic being received at a constant 20 Mbps, a transmit shaper can pace out the incoming traffic at 10 Mbps, inserting inter-packet gaps at a 50% duty cycle to achieve 10 Mbps. Based on the CoS queue filling past a configurable watermark, it will stall the transmit work scheduler from servicing that queue, which can cause traffic to start to build up in the network interface device memory as the data is paced out. Eventually, two types of drops may take place. A quota for this CoS queue can be reached and the shaper has paced out enough data for the buffer to fill and start to quota drop packets on RX. In some cases, the meter on receive will go over its 10 Mbps rate, beyond its configured burst size, and start to meter drop on RX. Which type of drop occurs first depends on the configured burst size and configured quota for that queue. Flow control can span across RX and TX, triggering eventually drops on the receive side.

For a single CoS queue with two subscribers, 1 CoS queue can be used with two flows classified, one into a 10 Mbps, another into a 20 Mbps limit. Traffic classified into the two flows arrive at 20 Mbps (for a total of 40 Mbps). The transmit shaper can start to pace out the incoming traffic for the first flow, while it will not pace the traffic for the second flow. Once the CoS queue fills past a configurable watermark, it can stall the transmit work scheduler from servicing that queue, which can cause traffic to start to build up in the NIC memory as the data is paced out for both flows, including the flow that is under rate. Two types of drops may take place. First, the quota for this CoS queue is reached and new packets coming into this CoS queue will be dropped regardless of which subscriber it came from. Second, the meter on receive will go over its 10 Mpps rate for the first flow, beyond its configured burst size, and start to meter drop on RX only traffic from the first flow. Which type of drop occurs first depends on the configured burst size and configured quota for that queue. This configuration can be applied if the burst size of the shaper on RX is smaller than the capacity in the CoS queue. In this case the shaper can trigger and start to groom the traffic into the network device buffer, attempting to avoid a pile up on transmit. Flow control from the transmit shaper may head of line (HOL) block the second flow, and if the queue depth limit is reached it could drop data from that innocent flow.

For a single CoS queue with 500K subscribers, at any given time, some percentage of the subscribers may be over their limit, causing pacing to trigger on transmit. As long as their burst sizes are configured correctly, and enough buffer is given to this CoS queue, the meters on receive may ensure that there is no HOL blocking or pacing of innocent flows. Per-subscriber rate enforcement and pacing can occur with a single layer of QoS.

For a single CoS queue, 499K Subscribers, 500 service nodes (2 layers), 4 uplink ports, 4 layers of shaping can also be applied.

For four CoS Queues and one subscriber, 4 CoS queues can be used (e.g., strict high priority and three weighted 50%, 25%, 25%). A subscriber can utilize four types of flows.

For 12K CoS Queues, 499K subscribers, 500 service nodes (2 layers), 4 uplink ports, CoS can be applied per subscriber, and separation across subscribers with different priorities

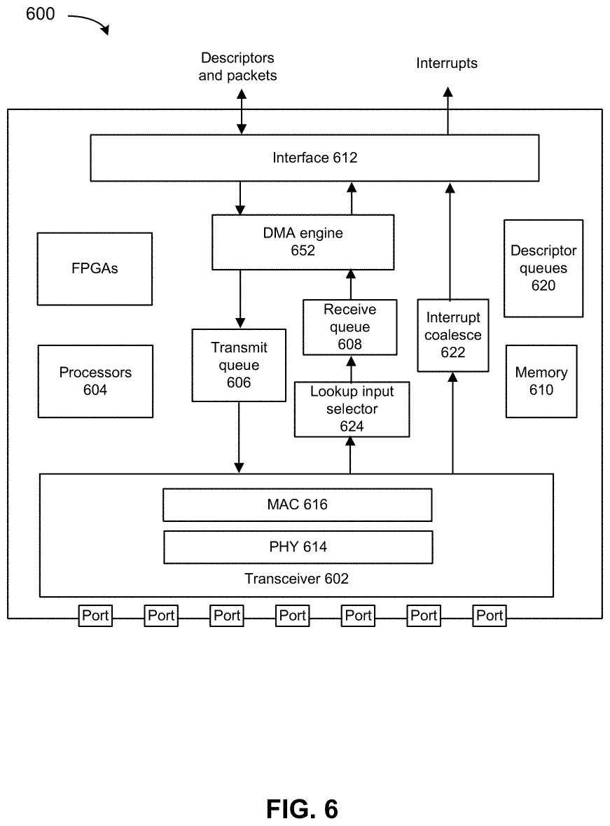

FIG. 6 depicts an example network interface device. A network interface device can be used to apply H-QoS as described herein. In some examples, network interface 600 can be implemented as a network interface controller, network interface card, a host fabric interface (HFI), or host bus adapter (HBA), and such examples can be interchangeable. Network interface 600 can be coupled to one or more servers using a bus, Peripheral Component Interconnect (PCIe), Compress Express Link (CXL), or Double Data Rate (DDR). Network interface 600 may be embodied as part of a system-on-a-chip (SoC) that includes one or more processors, or included on a multichip package that also contains one or more processors.

Some examples of network interface device 600 are part of an Infrastructure Processing Unit (IPU) or data processing unit (DPU) or utilized by an IPU or DPU. An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to perform MAC address filtering on received packets, process MAC headers of received packets by verifying data integrity, remove preambles and padding, and provide packet content for processing by higher layers. MAC circuitry 616 can be configured to assemble data to be transmitted into packets, that include destination and source addresses along with network control information and error detection hash values.

Processors 604 can be any a combination of a: processor, core, graphics processing unit (GPU), field programmable gate array (FPGA), application specific integrated circuit (ASIC), programmable packet processing pipelines, or other programmable hardware device that allow programming of network interface 600. For example, processors 604 can perform queue identification, packet dropping and/or rate limiting as described herein. For example, a “smart network interface” or SmartNIC can provide packet processing capabilities in the network interface using processors 604.

Packet allocator 624 can provide distribution of received packets for processing by multiple CPUs or cores using timeslot allocation described herein or RSS. When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer. Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with Peripheral Component Interconnect, PCIe, Peripheral Component Interconnect extended (PCI-x), Serial AT Attachment (ATA), and/or Universal Serial Bus (USB) compatible interface (although other interconnection standards may be used).

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, edge servers and switches, fog network elements, and/or hybrid data centers (e.g., data center that use virtualization, cloud and software-defined networking to deliver application workloads across physical data centers and distributed multi-cloud environments).

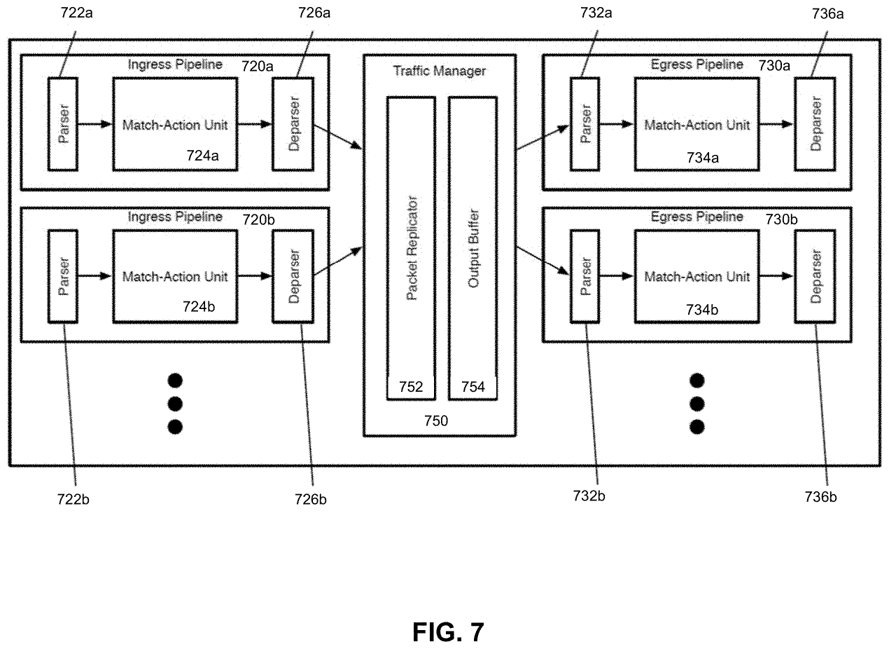

FIG. 7 depicts an example network forwarding system that can be used in a network interface device to apply H-QoS described herein. For example, FIG. 7 illustrates several ingress pipelines 720, a traffic management unit (referred to as a traffic manager) 750, and several egress pipelines 730. Though shown as separate structures, in some examples, the ingress pipelines 720 and the egress pipelines 730 can use the same circuitry resources. Pipeline circuitry can be configured to process ingress and/or egress pipeline packets synchronously, as well as non-packet data. That is, a particular stage of the pipeline may process any combination of an ingress packet, an egress packet, and non-packet data in the same clock cycle. However, the ingress and egress pipelines can be separate circuitry. The ingress pipelines can process the non-packet data.

In some examples, in response to receiving a packet, the packet is directed to one of the ingress pipelines 720 where an ingress pipeline which may correspond to one or more ports of a hardware forwarding element. After passing through the selected ingress pipeline 720, the packet is sent to the traffic manager 750, where the packet is enqueued and placed in the output buffer 754. Ingress pipeline 720 that processes the packet specifies into which queue the packet is to be placed by the traffic manager 750 (e.g., based on the destination of the packet or a flow identifier of the packet). The traffic manager 750 then dispatches the packet to the appropriate egress pipeline 730 where an egress pipeline may correspond to one or more ports of the forwarding element. In some examples, there is no necessary correlation between which of the ingress pipelines 720 processes a packet and to which of the egress pipelines 730 the traffic manager 750 dispatches the packet. That is, a packet might be initially processed by ingress pipeline 720b after receipt through a first port, and then subsequently by egress pipeline 730a to be sent out a second port, etc.

A least one ingress pipeline 720 includes a parser 722, a match-action unit (MAU) 724, and a deparser 726. Similarly, egress pipeline 730 can include a parser 732, a MAU 734, and a deparser 736. The parser 722 or 732 can receive a packet as a formatted collection of bits in a particular order, and parses the packet into its constituent header fields. In some examples, the parser starts from the beginning of the packet and assigns header fields to fields (e.g., data containers) for processing. Parser 722 or 732 can separate out the packet headers (up to a designated point) from the payload of the packet, and sends the payload (or the entire packet, including the headers and payload) directly to the deparser without passing through the MAU processing.

The MAU 724 or 734 can perform queue identification, packet dropping and/or rate limiting as described herein. MAU can include a sequence of stages, with each stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, using MAU, telemetry data for the forwarding element can be gathered and sent to another network interface device, switch, router, or endpoint receiver or transmitter in one or more packets.

One or more of ingress pipelines 720 and egress pipelines 730 can be configured to perform match-action on received packets to identify packet processing rules and next hops using information stored in a ternary content-addressable memory (TCAM) tables or exact match tables. For example, match-action tables or circuitry can be used whereby a hash of a portion of a packet is used as an index to find an entry. One or more of ingress pipelines 720 and egress pipelines 730 can be configured to perform access control list (ACL) or packet drops due to queue overflow. One or more of ingress pipelines 720 and egress pipelines 730 can be configured to add operation and telemetry data concerning switch 704 to a packet prior to its egress.

Configuration of operation of one or more of ingress pipelines 720 and egress pipelines 730, including its data plane, can be programmed using P4, C, Python, Broadcom Network Programming Language (NPL), or x86 compatible executable binaries or other executable binaries.

Deparser 726 or 736 can reconstruct the packet using the PHV as modified by the MAU 724 or 734 and the payload received directly from the parser 722 or 732. The deparser can construct a packet that can be sent out over the physical network, or to the traffic manager 750. The deparser can construct this packet based on data received along with the PHV that specifies the protocols to include in the packet header, as well as its own stored list of data container locations for each possible protocol's header fields.

Traffic manager 750 can include a packet replicator 752 and output buffer 754. In Traffic manager 750 may include other components, such as a feedback generator for sending signals regarding output port failures, a series of queues and schedulers for these queues, queue state analysis components, as well as additional components. The packet replicator 752 can perform replication for broadcast/multicast packets, generating multiple packets to be added to the output buffer (e.g., to be distributed to different egress pipelines). Traffic manager 750 can perform H-QoS scheduling as described herein.

The output buffer 754 can be part of a queuing and buffering system of the traffic manager. The traffic manager 750 can provide a shared buffer that accommodates any queuing delays in the egress pipelines. Shared output buffer 754 can store packet data, while references (e.g., pointers) to that packet data are kept in different queues for each egress pipeline 730. The egress pipelines can request their respective data from the common data buffer using a queuing policy that is control-plane configurable. When a packet data reference reaches the head of its queue and is scheduled for dequeuing, the corresponding packet data can be read out of the output buffer 754 and into the corresponding egress pipeline 730. Packet data may be referenced by multiple pipelines (e.g., for a multicast packet). In this case, the packet data is not removed from this output buffer 754 until all references to the packet data have cleared their respective queues.

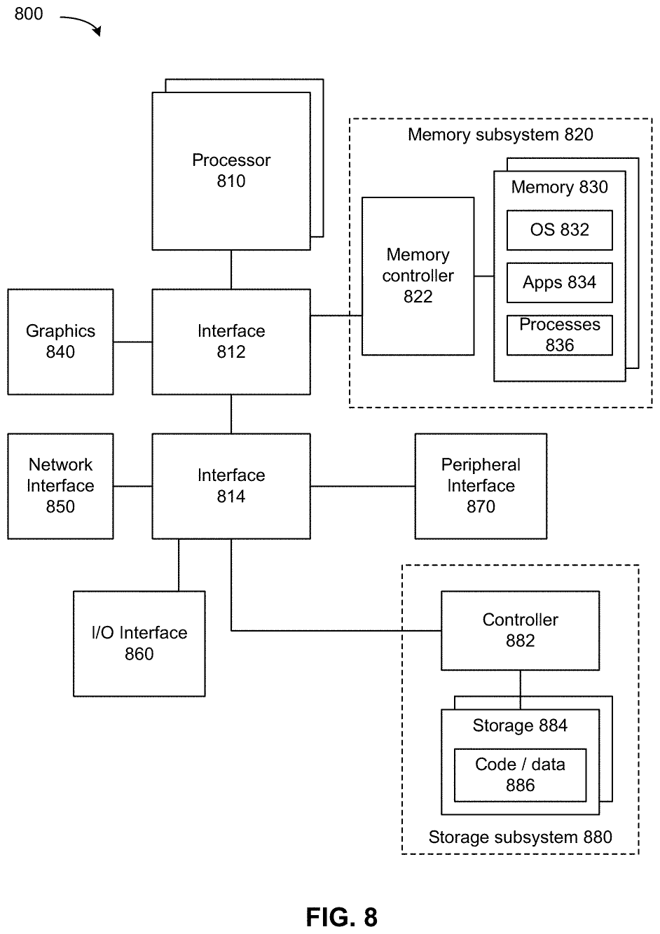

FIG. 8 depicts an example computing system. One or more components of system 800 can be used to determine queue selection, apply packet dropping, apply rate limiting, and/or H-QoS to packets described herein described herein. System 800 includes processor 810, which provides processing, operation management, and execution of instructions for system 800. Processor 810 can include any type of microprocessor, central processing unit (CPU), graphics processing unit (GPU), vision processing unit (VPU), processing core, or other processing hardware to provide processing for system 800, or a combination of processors. Note that reference to GPU or CPU herein can in addition or alternatively refer to an XPU or xPU. An xPU can include one or more of: a GPU, ASIC, FPGA, or accelerator device. Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a fixed function or programmable offload engine that can be accessed or used by a processor 810. For example, an accelerator among accelerators 842 can provide compression (DC) capability, cryptography services such as public key encryption (PKE), cipher, hash/authentication capabilities, decryption, or other capabilities or services. In addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 842 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. Network interface 850 can be configured to determine queue selection, apply packet dropping, apply rate limiting, and/or H-QoS to packets described herein described herein.

In one example, system 800 includes one or more input/output (I/O) interface(s) 860. I/O interface 860 can include one or more interface components through which a user interacts with system 800 (e.g., audio, alphanumeric, tactile/touch, or other interfacing). Peripheral interface 870 can include any hardware interface not specifically mentioned above. Peripherals refer generally to devices that connect dependently to system 800. A dependent connection is one where system 800 provides the software platform or hardware platform or both on which operation executes, and with which a user interacts.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory includes a cache. A memory subsystem as described herein may be compatible with a number of memory technologies, such as DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WI02 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 800. More specifically, power source typically interfaces to one or multiple power supplies in system 800 to provide power to the components of system 800. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, edge servers, edge switches, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.”’

Illustrative examples of the devices, systems, and methods disclosed herein are provided below. An embodiment of the devices, systems, and methods may include one or more, and combination of, the examples described below.

Example 1 includes one or more examples and includes an apparatus comprising: a network interface device, wherein the network interface device comprises: an Ethernet interface, a host interface, circuitry to be configured to copy a packet payload from a host device through the host interface, form a packet based on the packet payload, and transmit the packet through the Ethernet interface, and circuitry to be configured to apply rate limiting and/or traffic shaping for packets received through the Ethernet interface based on hierarchical quality of service (H-QoS).

Example 2 includes one or more examples, wherein the circuitry to be configured to apply rate limiting and/or traffic shaping for packets received through the Ethernet interface based on H-QoS comprises a programmable packet processing pipeline that is to be configured to perform one or more of: packet drops of packets received in excess of a receive rate, packet drops based on packet transmission in excess of a transmit rate, and/or traffic shaping of the received packets prior to transmission through one or more output ports.

Example 3 includes one or more examples, wherein to perform packet drops of packets received in excess of a receive rate, the programmable packet processing pipeline is to perform rate limiting per one or more of: class of service, subscriber, service, or interface.

Example 4 includes one or more examples, wherein to perform traffic shaping of the received packets prior to transmission through one or more output ports, the circuitry is to: perform traffic shaping for at least one uplink connection, wherein the at least one uplink connection is to connect a local area network to a wide area network and perform traffic shaping for at least one downlink connection, wherein the at least one downlink connection is to connect the local area network to the wide area network.

Example 5 includes one or more examples, wherein to perform traffic shaping of the received packets prior to transmission through one or more output ports, the circuitry is to: apply one or more traffic shapers to the received packets by performance of traffic shaping at one or more of: class of service level, subscriber level, service node level, or an output port level.

Example 6 includes one or more examples, wherein the network interface device comprises circuitry to store at least one of the received packets in at least one per-subscriber class of service (CoS) queue, wherein subscribers with a shared CoS profile and subscriber weight share a per-subscriber CoS queue.

Example 7 includes one or more examples, wherein the circuitry to be configured to apply rate limiting and/or traffic shaping for packets received through the Ethernet interface based on H-QoS is to apply rate limiting and/or traffic shaping for packets received through the Ethernet interface based on one or more of: a P4-consistent program, a Broadcom Network Programming Language (NPL)-consistent program, and/or a Python-consistent program.

Example 8 includes one or more examples, wherein a control plane is to configure the circuitry to be configured to apply rate limiting and/or traffic shaping for packets received through the Ethernet interface based on H-QoS.

Example 9 includes one or more examples, wherein the network interface device comprises one or more of: a network interface controller (NIC), smartNIC, infrastructure processing unit (IPU), data processing unit (DPU), network interface card, and/or fabric interface.

Example 10 includes one or more examples, and includes one or more of a server, rack, or data center, wherein the network interface device is coupled to the one or more of a server, rack, or data center and wherein the network interface device is to copy the packet payload from the one or more of a server, rack, or data center through the host interface.

Example 11 includes one or more examples, and includes a method comprising: configuring, by a control plane, a network interface device to apply rate limiting and/or traffic shaping for packets received through an Ethernet interface based on hierarchical quality of service (H-QoS), wherein the network interface device comprises the Ethernet interface, a host interface, and circuitry to be configured to copy a packet payload from a host device through the host interface, form a packet based on the packet payload, and transmit the packet through the Ethernet interface.

Example 12 includes one or more examples, wherein the network interface device applies rate limiting and/or traffic shaping for packets received through the Ethernet interface based on H-QoS by a programmable packet processing pipeline and wherein the rate limiting and/or traffic shaping for packets received through the Ethernet interface based on H-QoS by a programmable packet processing pipeline comprises one or more of: packet dropping of packets received in excess of a receive rate, packet dropping based on packet transmission in excess of a transmit rate, and/or traffic shaping of the received packets prior to transmission through one or more output ports.

Example 13 includes one or more examples, wherein the packet dropping of packets received in excess of a receive rate comprises performing rate limiting per one or more of: class of service, subscriber, service, or interface.

Example 14 includes one or more examples, wherein the traffic shaping of the received packets prior to transmission through one or more output ports comprises applying one or more traffic shapers to the received packets by performance of traffic shaping at one or more of: class of service level, subscriber level, service node level, or an output port level.

Example 15 includes one or more examples, and includes configuring the network interface device to store at least one of the received packets in at least one per-subscriber class of service (CoS) queue, wherein subscribers with a shared CoS profile and subscriber weight share a per-subscriber CoS queue.

Example 16 includes one or more examples, wherein the configuring, by the control plane, the network interface device to apply rate limiting and/or traffic shaping for packets received through the Ethernet interface based on H-QoS comprises configuration based on one or more of: a P4-consistent program, a Broadcom Network Programming Language (NPL)-consistent program, and/or a Python-consistent program.

Example 17 includes one or more examples, and includes a non-transitory computer-readable medium comprising instructions, that if executed by one or more processors, cause the one or more processors to: perform, in a network interface device, rate limiting and/or traffic shaping for packets received through an Ethernet interface based on hierarchical quality of service (H-QoS), wherein the network interface device comprises the Ethernet interface, a host interface, and circuitry to be configured to copy a packet payload from a host device through the host interface, form a packet based on the packet payload, and transmit the packet through the Ethernet interface.

Example 18 includes one or more examples, wherein the network interface device is to apply rate limiting and/or traffic shaping for packets received through the Ethernet interface based on H-QoS by a programmable packet processing pipeline and wherein the rate limiting and/or traffic shaping for packets received through the Ethernet interface based on H-QoS by a programmable packet processing pipeline comprises one or more of: packet dropping of packets received in excess of a receive rate, packet dropping based on packet transmission in excess of a transmit rate, and/or traffic shaping of the received packets prior to transmission through one or more output ports.

Example 19 includes one or more examples, wherein to perform packet dropping of packets received in excess of a receive rate, the network interface device is to perform rate limiting per one or more of: class of service, subscriber, service, or interface.

Example 20 includes one or more examples, wherein to perform traffic shaping of the received packets prior to transmission through one or more output ports, the network interface device is to perform traffic shaping per one or more of: class of service level, subscriber level, service node level, or an output port level.

1. An apparatus comprising:
a network interface device, wherein the network interface device comprises:
an Ethernet interface,
a host interface,
circuitry to be configured to copy a packet payload from a host device through the host interface, form a packet based on the packet payload, and transmit the packet through the Ethernet interface, and
circuitry to be configured to apply rate limiting and/or traffic shaping for packets received through the Ethernet interface based on hierarchical quality of service (H-QoS).

2. The apparatus of claim 1, wherein the circuitry to be configured to apply rate limiting and/or traffic shaping for packets received through the Ethernet interface based on H-QoS comprises a programmable packet processing pipeline that is to be configured to perform one or more of: packet drops of packets received in excess of a receive rate, packet drops based on packet transmission in excess of a transmit rate, and/or traffic shaping of the received packets prior to transmission through one or more output ports.

3. The apparatus of claim 2, wherein to perform packet drops of packets received in excess of a receive rate, the programmable packet processing pipeline is to perform rate limiting per one or more of: class of service, subscriber, service, or interface.

4. The apparatus of claim 1, wherein to perform traffic shaping of the received packets prior to transmission through one or more output ports, the circuitry is to:
perform traffic shaping for at least one uplink connection, wherein the at least one uplink connection is to connect a local area network to a wide area network and
perform traffic shaping for at least one downlink connection, wherein the at least one downlink connection is to connect the local area network to the wide area network.

5. The apparatus of claim 1, wherein to perform traffic shaping of the received packets prior to transmission through one or more output ports, the circuitry is to:
apply one or more traffic shapers to the received packets by performance of traffic shaping at one or more of: class of service level, subscriber level, service node level, or an output port level.

6. The apparatus of claim 1, wherein the network interface device comprises circuitry to store at least one of the received packets in at least one per-subscriber class of service (CoS) queue, wherein subscribers with a shared CoS profile and subscriber weight share a per-subscriber CoS queue.

7. The apparatus of claim 1, wherein the circuitry to be configured to apply rate limiting and/or traffic shaping for packets received through the Ethernet interface based on H-QoS is to apply rate limiting and/or traffic shaping for packets received through the Ethernet interface based on one or more of: a P4-consistent program, a Broadcom Network Programming Language (NPL)-consistent program, and/or a Python-consistent program.

8. The apparatus of claim 1, wherein a control plane is to configure the circuitry to be configured to apply rate limiting and/or traffic shaping for packets received through the Ethernet interface based on H-QoS.

9. The apparatus of claim 1, wherein the network interface device comprises one or more of: a network interface controller (NIC), smartNIC, infrastructure processing unit (IPU), data processing unit (DPU), network interface card, and/or fabric interface.

10. The apparatus of claim 1, comprising one or more of a server, rack, or data center, wherein the network interface device is coupled to the one or more of a server, rack, or data center and wherein the network interface device is to copy the packet payload from the one or more of a server, rack, or data center through the host interface.

11. A method comprising:
configuring, by a control plane, a network interface device to apply rate limiting and/or traffic shaping for packets received through an Ethernet interface based on hierarchical quality of service (H-QoS), wherein the network interface device comprises the Ethernet interface, a host interface, and circuitry to be configured to copy a packet payload from a host device through the host interface, form a packet based on the packet payload, and transmit the packet through the Ethernet interface.

12. The method of claim 11, wherein the network interface device applies rate limiting and/or traffic shaping for packets received through the Ethernet interface based on H-QoS by a programmable packet processing pipeline and wherein the rate limiting and/or traffic shaping for packets received through the Ethernet interface based on H-QoS by a programmable packet processing pipeline comprises one or more of: packet dropping of packets received in excess of a receive rate, packet dropping based on packet transmission in excess of a transmit rate, and/or traffic shaping of the received packets prior to transmission through one or more output ports.

13. The method of claim 12, wherein the packet dropping of packets received in excess of a receive rate comprises performing rate limiting per one or more of: class of service, subscriber, service, or interface.

14. The method of claim 12, wherein the traffic shaping of the received packets prior to transmission through one or more output ports comprises applying one or more traffic shapers to the received packets by performance of traffic shaping at one or more of: class of service level, subscriber level, service node level, or an output port level.

15. The method of claim 11, comprising:
configuring the network interface device to store at least one of the received packets in at least one per-subscriber class of service (CoS) queue, wherein subscribers with a shared CoS profile and subscriber weight share a per-subscriber CoS queue.

16. The method of claim 11, wherein the configuring, by the control plane, the network interface device to apply rate limiting and/or traffic shaping for packets received through the Ethernet interface based on H-QoS comprises configuration based on one or more of: a P4-consistent program, a Broadcom Network Programming Language (NPL)-consistent program, and/or a Python-consistent program.

17. A non-transitory computer-readable medium comprising instructions, that if executed by one or more processors, cause the one or more processors to:
perform, in a network interface device, rate limiting and/or traffic shaping for packets received through an Ethernet interface based on hierarchical quality of service (H-QoS), wherein the network interface device comprises the Ethernet interface, a host interface, and circuitry to be configured to copy a packet payload from a host device through the host interface, form a packet based on the packet payload, and transmit the packet through the Ethernet interface.

18. The computer-readable medium of claim 17, wherein the network interface device is to apply rate limiting and/or traffic shaping for packets received through the Ethernet interface based on H-QoS by a programmable packet processing pipeline and wherein the rate limiting and/or traffic shaping for packets received through the Ethernet interface based on H-QoS by a programmable packet processing pipeline comprises one or more of: packet dropping of packets received in excess of a receive rate, packet dropping based on packet transmission in excess of a transmit rate, and/or traffic shaping of the received packets prior to transmission through one or more output ports.

19. The computer-readable medium of claim 17, wherein to perform packet dropping of packets received in excess of a receive rate, the network interface device is to perform rate limiting per one or more of: class of service, subscriber, service, or interface.

20. The computer-readable medium of claim 17, wherein to perform traffic shaping of the received packets prior to transmission through one or more output ports, the network interface device is to perform traffic shaping per one or more of: class of service level, subscriber level, service node level, or an output port level.
